(19) United States
(12) Patent Application Publication
(10) Pub. No.: US 2004/0174298 A1
(43) Pub. Date: Sep. 9, 2004

(54) Intelligent antenna using position data stored in data base to steer antenna beam towards mobile station

(76) Inventor: Timo Eriksson, Tokyo (JP)

Correspondence Address: HARRINGTON & SMITH, LLP, 4 RESEARCH DRIVE, SHELTON, CT, 06484-6212, US

(21) Appl. No.: 10/476,281

(22) PCT Filed: May 2, 2002
(86) PCT No.: PCT/IB02/01553

(30) Foreign Application Priority Data
May 4, 2001 (GB) 0110013.9

(51) Int. Cl. H01Q 3/00

(52) U.S. Cl. 342/359; 342/368; 342/357.1

(57) ABSTRACT

A communication system for communicating with a portable radio telephone is disclosed. The system comprises a transceiver, an antenna capable of directing a beam in a given angular direction, a database for storing information relating a location of the portable radio telephone to an angular beam direction, and a controller for configuring the antenna for communication with the portable radio telephone by directing a beam in the angular direction indicated in the database.

This invention relates to a communication system having a base station with an antenna of the beam-forming or steered beam type.

Beam-forming antennas are antennas which are capable of dynamically altering their radiation patterns. They may comprise an array of phased antenna elements which can be configured electronically or mechanically to be more sensitive to signals from a particular direction in receive mode, or to transmit signals more selectively in a particular direction in transmit mode.

Such antennas capable of providing steered beams of this sort are also termed smart antennas.

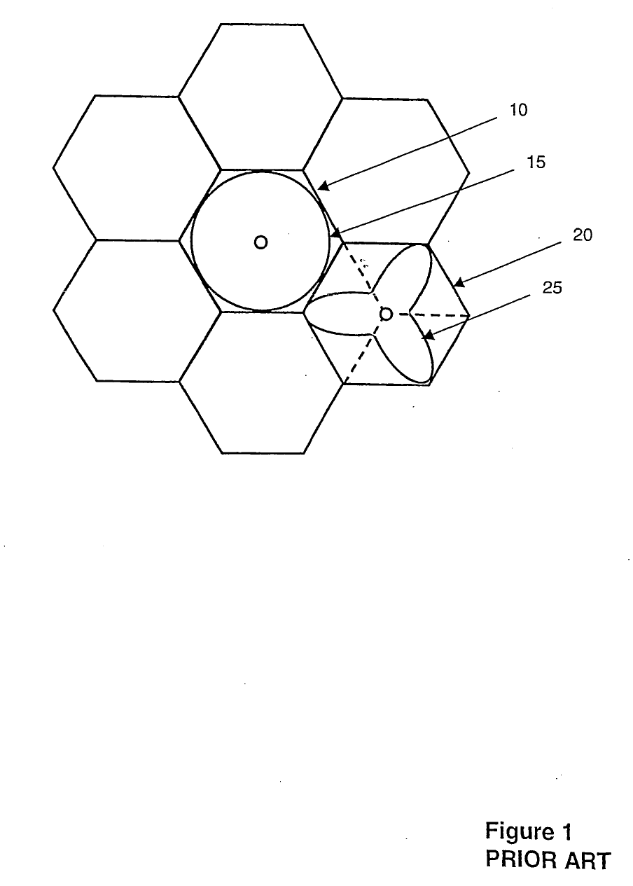

Current cellular communication systems tend to use base stations having an omni-directional antenna i.e. an antenna which radiates signals equally in all directions (360°). FIG. 1 shows a number, of cells. The central cell 10 has a base station (BS) at its centre associated with an antenna having an omni-directional antenna. The radiation pattern of the antenna is represented by the circle 15. The radiation pattern extends equally 360° around the antenna.

Adjacent to cell 10 is cell 20 having an alternative configuration to the omni-directional setup of cell 10. Cell 20 has a sectorised configuration. In this case, the base station at the centre of the has 3 distinct sets of antennas associated with it. Each set of antennas is arranged to transmit to and receive from a 120° sector of the cell. The radiation pattern covering the cell 20 is shown by the tri-lobed shape 25.

In the first of these configurations, the antenna is operable to transmit/receive signals across all of the respective cell or sector i.e. there is no selectivity based on the location of the MS being communicated with. Consequently, only a fraction of the energy transmitted from the antenna is directed towards the desired MS.

In the second configuration, some degree of directivity is possible, due to the sectorised configuration, but a large amount of energy is still directed away from the intended recipient.

Schemes have been proposed using an access technique known as Space Division Multiple Access (SDMA). Unlike Frequency Division Multiple Access (FDMA), Time Division Multiple Access (TDMA) and Code Division Multiple access (CDMA) which distinguish between different users according to their frequency, timeslot or coding scheme respectively, SDMA distinguishes between different users according to their geographical position.

SDMA systems rely on a highly directional antenna which is capable of dynamically directing a beam in the precise direction of the MS, thus enabling the transmitted energy to be more effectively used, as it is only being directed at the intended recipients. In receive mode, the antenna can steer a receive lobe in the precise direction of the MS. In this way, interfering signals from other MSs may be effectively ignored, as the antenna's response in their direction is much inferior to the response in the wanted direction.

Hybrid systems have also been proposed which incorporate some features of TDMA and/or FDMA and/or CDMA with SDMA. In such a scheme, it is possible for the BS to communicate with two MSs occupying the same timeslot and frequency channel but situated at different locations within the cell's service area. Such hybrid systems offer the possibility of increased frequency spectrum utilisation compared with a system based on a single scheme.

A problem with employing SDMA in current communication systems is that it can be difficult to know the location of the MS with the accuracy needed to direct a beam in its direction. However, the so-called third generation of communication systems aims to incorporate improved facilities for determining the location of an MS. It is thought that third generation handsets will routinely include a GPS receiver, or some other device, which will allow the network to determine the location of each MS with an accuracy to the nearest one metre.

The motivation to provide the improved location information is to enable the provision of location dependent information services to the user and also to enable the location of the user to be determined in an emergency situation.

By making use of this very accurate location information, the network base station can direct a beam in the precise direction of the MS.

However, a problem arises when using MSs in crowded urban environments, and also in other environments having features, e.g. hills, which may impede the transmission or reception of radio signals. It is well known, especially in urban environments, that multipath effects arise, whereby signals transmitted in both directions between a BS and an MS may take several different routes between their source and destination.

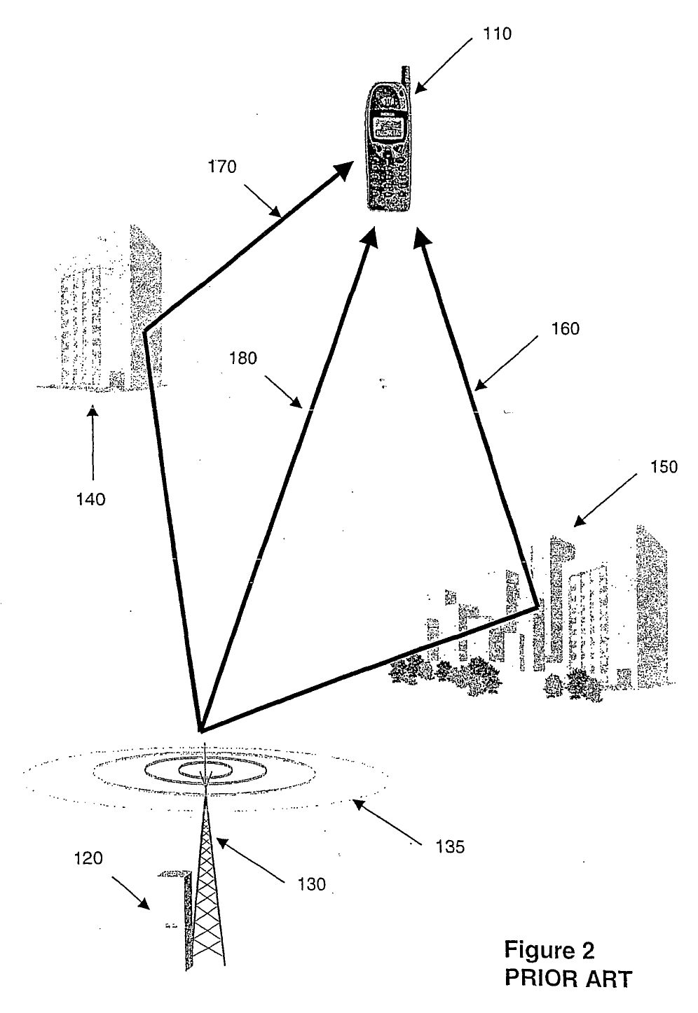

This situation is shown in FIG. 2. The base station 120 transmits and receives via an antenna 130. The antenna is an omni-directional antenna and transmits and receives in all directions 135. The MS 110 is located some distance away from the base station 120, and the signal that it receives comprises several components which arrive via many different routes.

In the example shown, the MS receives signals via three different routes. In practice, reception may occur via many more routes than this. The first route via which a signal is received is the direct route 180, which probably yields the strongest signal component. The second 170 and third 160 routes are defined by reflections from different buildings. Each of these signals will be delayed slightly relative to the first signal.

It can be seen that only a fraction of the radiated energy from the base station antenna 130 reaches the MS 110. The rest of the transmitted energy is effectively wasted.

The situation when the MS 110 is transmitting is similar. The MS generally transmits via an omni-directional antenna, and only a small fraction of the transmitted energy is directed towards the base station 120. As transmission accounts for the bulk of the energy consumed by the MS 110 any economies which can be made in transmit power can have a great impact on battery life.

According to a first aspect of the present invention there is provided a communication system for communicating with a portable radio telephone, comprising: a transceiver; an antenna capable of directing a beam in a given angular direction; a database for storing information relating a location of the portable radio telephone to an angular beam direction; control means, responsive to the determination of the location of a mobile station, for configuring the antenna for communication with the portable radio telephone by directing a beam in the angular direction related in the database to the determined location of the mobile station.

According to a second aspect of the present invention there is provided a method of configuring a base station having a steered beam antenna for use with a communication system, comprising the steps of: transmitting a test signal from the base station as a beam is incrementally steered in a plurality of angular directions; measuring the received strength of the test signal at a defined location; recording the angular direction at which a received signal strength exceeds a predetermined threshold.

In prior art smart antenna systems, the base station, being aware of the location of the MS with which it is communicating, calculates the angular position of the MS relative to its own position and steers a beam in that direction. However, due to complex geography or terrain, directing a beam in the angular direction of the MS may not be the optimum solution. Unlike omni-directional systems, where some of the transmitted energy may reach the MS wherever it is in a cell, a steered beam system which transmits in a direction where the MS can not receive the signal may prove useless.

Advantageously, communication systems according to embodiments of the present invention benefit from improved communication between a Base Station (BS) and a communicating Mobile Station (MS). This is due to the ‘knowledge’ built into the system which links the position of an MS to one or more optimum angular directions in which a beam or beams should be steered for reception and transmission purposes.

In the absence of such ‘knowledge’, particularly in urban environments, there is a chance that, in situations where an MS is partially or wholly obscured from a ‘line of sight’ path to or from the BS, the communication link may be lost or will suffer or generate unnecessary interference due to the consequently lower received signal strength. In particular with CDMA systems, the performance of the entire system may degrade.

It is obviously a time consuming and laborious task to try and measure the optimum angular beam directions for all locations within a base station's service area, so the software in the base station may be configured to use interpolation techniques to calculate an angular beam direction on the basis of two or more neighbouring locations. In this way, an improvement may be made on the prior art solution which simply directs a beam in the angular direction of the location of the MS.

Advantageously, the system may be configured to ‘learn’ about its service area as time goes on. In the above described situation, where interpolation is used to calculate a beam direction, the base station may be configured to sweep the beam around the prior stored directions for each calculated location to seek out a true optimum direction. Such an optimum direction may then be updated or added to the database and related to the reported location of the MS. Such measurements may be made frequently during the early life of the BS, when there is likely to be little radio traffic, and so spare resources are available at the BS, or they may be made less frequently but continually over the lifetime of the BS, in the latter case, the BS can adapt to its slowly changing environment and take account of new buildings, for instance, which may change the local propagation characteristics.

MSs communicating with a BS operable according to embodiments of the invention are likely to enjoy a longer battery life than MSs communicating with a prior art BS. Another advantage is that higher data rates are achievable in relatively larger cells, where previously only relatively smaller cells could support rates in excess of 10 Mbps. This is because in the prior art systems, MSs are required to transmit at powers suitable for overcoming interfering signal which may be coming from sources anywhere within the operating area of the BS. When an MS is in communication with a BS operable according to embodiments of the invention, then the selectivity afforded by the steered beam means that the BS is ‘deaf’ to interfering signals not falling within the beam. As such, the MS is able to operate at a lower transmit power, since it does not have to compete with other signals to the same extent. Lower transmit powers translate directly into longer battery life, as transmission accounts for the bulk of battery usage in most MSs.

Preferably, the MS is able to determine its position accurately using a satellite positioning system such as GPS. However, if this is not available, improvements over the prior art are possible if the position of the MS can be determined using known techniques such as triangulation, where the position of the MS can be calculated on the basis of the timing of signals received at or transmitted by a number of base stations.

For a better understanding of the present invention, and to understand how the same may be brought into effect, the invention will now be described, by way of example only, with reference to the appended drawings in which:

FIG. 1 shows prior art configurations of cell sites and antennas;

FIG. 2 shows multipath propagation effects known in the prior art;

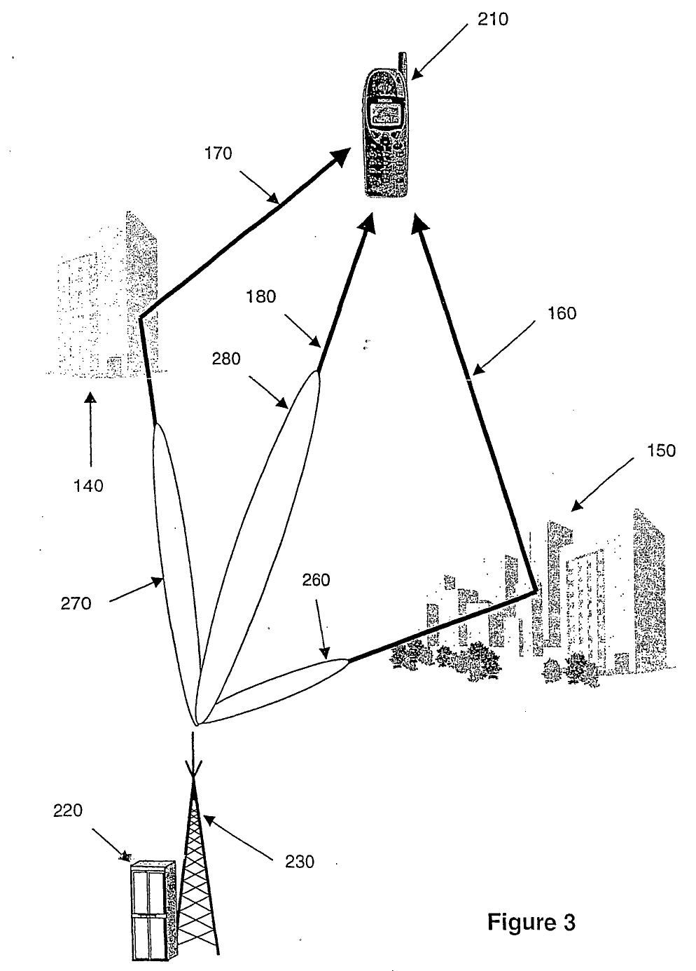

FIG. 3 shows an embodiment of the invention having an antenna providing multiple steered beams;

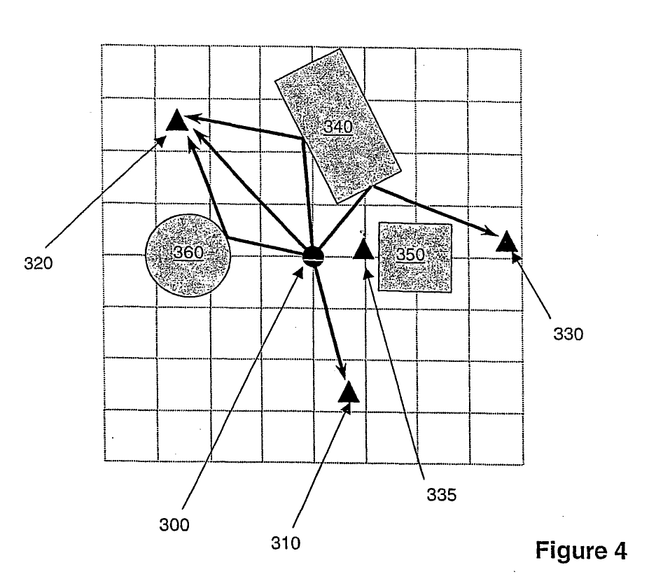

FIG. 4 shows part of an area of operation of a base station according to an embodiment of the invention;

An embodiment of the invention is shown at FIG. 3. The urban geography is the same as that shown in FIG. 2, but the base station 220 and antenna 230 are configured and operated differently.

The antenna 230 is not an omni-directional antenna as described previously. It is a smart antenna and is capable of directing beams or lobes 260, 270, 280 in a direction or directions controlled by the base station 220.

The MS 210 in this example is equipped with a locating device. A suitable device is a GPS receiver. Data from the GPS receiver is periodically communicated to the network, via the BS 220 so that its precise location may be determined. This information is gathered by, and made available to, software in the base station 220.

Since the base station is aware of the exact location of each MS with which it is in contact, it is able to control the smart antenna so that a beam or beams may be steered in the optimum direction for communication with that MS. By so doing, the beam steering process is adapted to allow for local terrain resulting in a need to transmit less energy from the BS in order to achieve satisfactory signal strength at the MS.

FIG. 3 shows an MS 210 situated some distance away from the BS 220. Tests previously performed using the BS have determined that for an MS positioned at the location occupied by the MS 210, the main signal component is received from direction 180. Two lesser signals are received via reflections 160 and 170 from buildings 150 and 140 respectively.

The calibration process, which is performed when the base station is commissioned, ensures that the BS has, in a database, information which relates the position of the MS 210 to the beam directions which produce the optimum received signal. Therefore, knowing the position of the MS 210, the BS can direct beams 260, 270 and 280 to arrive at the MS from directions 160, 170 and 180 respectively.

The database can be physically co-located with the BS., or may be centrally located at a network control centre, or distributed between these or other network elements.

In situations where it is not possible to steer a beam directly at an MS, it is possible using embodiments of the invention to ‘bounce’ a signal in their direction by purposely reflecting a beam of a building or other structure.

This situation is shown more clearly in FIG. 4. Here, the location of the BS 300 is at the centre of the grid which represents part of its service area. The shaded areas represent obstacles which impede the radio signals either partially or completely. 340 and 350 are buildings, and 360 is a gasometer. The triangles 310, 320 and 330 each represent an MS at various positions within the service area of the BS.

Looking at each MS in turn: 310 has a direct unimpeded path to the BS, and so the BS is able to steer a beam directly at the MS.

MS 320 has a direct path to the BS, but also receives a large signal as a reflection from the gasometer structure 360, and a further signal reflected from building 340.

MS 330 has no direct path to the BS, as it is behind building 350. However, it is possible to direct a beam to be reflected from building 340 which will reach the MS in its ‘shadowed’ position. The BS knows to do this due to the data in its database which was built up during calibration and setup of the BS. In this case, the beam must be directed approximately 45° away from the true location of the MS in order to reflect the signal towards the MS behind the building 350.

The MS 335, which is situated in front of the building 350, lies in the same angular direction from the BS as MS 330, which is obscured behind the building 350. A prior art system, which directs a beam purely on the basis of actual physical location of the MS, would direct a beam in the same direction for each of the MSs 330 and 335. As can be seen from FIG. 4, such an approach would result in an error of nearly 45° for the beam required to communicate with MS 330.

Before a base station and antenna according to an embodiment of the invention is fully operational on its associated communication network, calibration of the site is performed. The calibration process involves measuring received signal strength at a variety of points around the service area of the base station as a beam is incrementally swept around 360° by the base station and antenna. The process can be assisted by means of simulation tools that can estimate the beam directions based on the MS location and environment model (e.g. by means of ray-tracing techniques).

Any signal received from a particular angle which exceeds a defined threshold may be stored in the database, and so identified as one of possibly many optimal directions in which a beam should be directed for communication with an MS at the recorded position.

In this way, a record can be built up of the beam directions necessary in order to achieve optimum transmission/reception with an MS located at a given grid reference within the service area of the base station.

For instance, at a given x,y grid location, a suitably equipped MS could report back to the BS, or record locally, the signal strength of a received test signal as the BS incrementally rotates a transmission beam around 360°. As the beam approaches the angular direction at which the MS is situated, there is likely to be a peak in the received signal strength at the MS. However, this is not necessarily the case in an urban environment, where the peak in signal strength may be experienced with the transmission beam directed a few or many degrees away from the MS's actual location.

Once such tests have been performed at a variety of locations around the cell, the data can be recorded in a database which cross refers the x,y position of the MS with parameters related to one or more beams which will produce the optimum transmission or reception with an MS at that particular location.

The data stored in the database comprises records having as a primary field position data. The position data may be stored in Cartesian format (x,y), or alternatively in polar format (rθ, where r=distance from base station, and θ=angle from a defined start point). If Cartesian format is used, then standard grid references, as obtainable from GPS, may be used. Either method, or an alternative method which is able to uniquely identify a given location, can be used.

In a secondary field of each record is the angular beam information. This comprises one or more angular beam directions, and if there is more than one direction associated with a given location, the relative amount of transmission power to be directed in each direction indicated. In this way, more energy can be directed in an optimal direction.

An example part of the database may resemble:

| Location x, y | Beam Direction(s) | Relative Transmit Power |
|---|---|---|
| 1364, 5428 | 37° | |
| 1365, 5430 | 38°, 45° | 75%, 25% |
| 1366, 5450 | 42°, 50°, 55° | 40%, 30%, 30% |

It may be possible to use interpolation and/or simulation techniques to provide data for locations which have no empirical data recorded for them. Thus, a beam angle could be calculated on the basis of two or more nearby locations for which data is recorded in the data base:

Angle(x₁,y₁)=func(angle(x₂,y₂), angle(x₃,y₃) . . . angle(xₙ,yₙ))

If the MS has a direct path to the base station, then the optimum beam direction is likely to correspond with the direct path. There may be no need for more than a single beam in that direction. However, at a position where a direct path is not possible, then the optimum solution may be two or more beams directed in directions not corresponding with the direct path to the MS.

Of course, it is impractical to take measurements for every possible position within the service area of a base station. Consequently, measurements are taken at a variety of different locations, and entries are made in the database as described. Over the course of the life of the base station, software may be used which allows the base station to learn more about its service area.

The interpolation/simulation calculation described above provides a means by which unknown areas in the service area may be handled. If the BS has sufficient spare processing power, e.g. it is not carrying much traffic, then it may be possible to explore the region around the angular direction identified by the interpolation calculation.

For instance, an MS is located at a given location, which is not identified in the database, and an angular beam direction is calculated on the basis of two or more neighbouring locations. This angular beam direction may be suitable, but there may be a better direction which could be used.

The BS may be configured to sweep the beam around the angle indicated by the interpolated result. If the communication link improves, in terms of received signal strength of the MS signal, or a reported improved link quality from the MS, then this new direction, or directions, are registered in the database as the optimum beam direction(s) for an MS at the present location of the MS.

Over the lifetime of the BS, therefore, it is able to build up extensive knowledge about its local environment, and can even take into account new buildings or other structures which may affect the propagation paths to and from MSs.

A particular problem with communication systems employing a beam forming antenna at a BS is that of initial access to the system by an MS. If a BS is in communication with a particular MS, then it must keep track of its movements as the MS moves around the cell. In this way, it can always steer a beam in the appropriate direction. However, before a link has been established, the BS does not direct a beam towards MSs with which it is not in communication even if they are within its service area.

Since it is not yet feasible to implement smart antennas in MSs, the antennas used in MSs are omni-directional. This means that most of the power which is transmitted from MSs fails to reach the BS antenna.

Once communication has been established, the BS can selectively direct a receive beam in the direction of the MS to reduce the interfering signals which might otherwise hinder its reception of the wanted signal from the MS.

In order to initiate a call, the BS is operable in omni-directional mode for a defined period which occurs at certain times and with a certain frequency known to the MS. Therefore, the MS may make an access request at high power, and the BS does not need to know the location of the MS before a communication link is established with it. Once the access request has been allowed, and a link has been set up between the BS and the MS, the BS may direct a beam in the appropriate direction for the MS, as the MS's location information has been included in the access request or estimated by other means e.g. triangulation.

Once the BS is aware of the direction in which to steer a beam for communication with the MS, the MS may be able to operate on a lower transmit power, as the BS is able to more clearly distinguish signals from it due to the high selectivity of the antenna in steered beam mode. The MS is thus able to conserve battery power when compared to an MS in communication with a BS operating in omni-directional mode, where the MS in such a system generally has to use more transmit power in order to overcome interference from other signal sources in the same cell.

In broadband applications, it is particularly important to setup a robust link which is as error-free as possible between the BS and the MS. High data rates tend to require higher transmission powers in order to setup reliable links. Such a requirement of higher transmission power militates against larger cell sizes as it is difficult to maintain the required power level at the cell boundaries without transmitting excessive power levels from the antenna. The current understanding is that in order to support data rates of between 10-50 Mbps, the cell size can be no larger than 200 metres.

Such relatively small cell sizes mean that even small linear movements of the MS can result in large angular changes in position. For instance, an MS at the edge of a 200 m radius cell moving 20 m can result in an angular change of approximately 5.7°. The same MS at the edge of a 5 km radius cell moving 20 m results in an angular change of only 0.2°.

This means that the BS must update the direction of the angular beam often enough that it always effectively targets the MS. The frequency of the update depends on many factors including the relative proximity to the BS, the speed of movement of the MS and the availability of location information for the MS.

In the foregoing description, particularly with regard to antenna performance and characteristics, the skilled man will immediately appreciate that any references to transmission apply equally to reception where appropriate, and vice versa.

The present invention includes any novel feature or combination of features disclosed herein either explicitly or any generalisation thereof irrespective of whether or not it relates to the claimed invention or mitigates any or all of the problems addressed.

1. A communication system for communicating with a portable radio telephone, comprising:
a transceiver;
an antenna capable of directing a beam in a given angular direction;
a database for storing information relating a location of the portable radio telephone to an angular beam direction;
control means, responsive to the determination of the location of a mobile station, for configuring the antenna for communication with the portable radio telephone by directing a beam in the angular direction related in the database to the determined location of the mobile station.

2. A communication system as claimed in claim 1 wherein the database comprises information relating a plurality of locations within a service of the transceiver to a respective angular beam direction.

3. A communication system as claimed in claim 1 or claim 2 wherein the database is configured to store information relating the location of the portable radio telephone to a plurality of angular beam directions.

4. A communication system as claimed in claim 3 wherein the control means is operable to configure the antenna for communication with the portable radio telephone by directing a beam in each of the plurality of angular directions indicated in the database.

5. A communication system as claimed in any one of claims 3 or 4 wherein if the database comprises information relating more than one angular direction to each location, then each angular direction is associated with a relative transmission power level.

6. A communication system as claimed in any one of the preceding claims wherein the angular direction of the beam is different to the angular direction of the portable radio telephone.

7. A communication system as claimed in any one of the preceding claims wherein the control means is operable to determine an angular direction for a beam on the basis of interpolation from information in the database.

8. A communication system as claimed in any one of the preceding claims wherein the database is located locally with the transceiver.

9. A communication system as claimed in any one of claims 1 to 7 wherein the database is located centrally in the communication system.

10. A communication system as claimed in any one of the preceding claims wherein the location of the portable radio telephone is determined using a satellite positioning system.

11. A communication system as claimed in any one of claims 1 to 9 wherein the location of the portable radio telephone is determined on the basis of triangulation from known positions of transceivers forming part of the communication system.

12. A communication system as claimed in any one of the preceding claims wherein the antenna is operable in an omni-directional mode for the purposes of a portable radio telephone initiating access to the communication system.

13. A method of configuring a base station having a steered beam antenna for use with a communication system, comprising the steps of:
transmitting a test signal from the base station as a beam is incrementally steered in a plurality of angular directions;
measuring the received strength of the test signal at a defined location;
recording the angular direction at which a received signal strength exceeds a predetermined threshold.
